(19) United States
(12) Patent Application Publication
(10) Pub. No.: US 2006/0053994 A1
(43) Pub. Date: Mar. 16, 2006

(54) Rotary trimming apparatus

(76) Inventors: Gregory J. Carrillo, Remeoville, IL (US); Colin Knight, Skokie, IL (US)

Correspondence Address: Martin Faier, Faier & Faier P.C., #600, 566 W. Adams St., Chicago, IL, 60661, US

(21) Appl. No.: 10/940,501

(22) Filed: Sep. 13, 2004

(51) Int. Cl. B26D 7/02; B26D 1/18

(52) U.S. Cl. 83/485; 83/455; 83/489

(57) ABSTRACT

A rotary trimming apparatus includes a base for receiving a material, a rail mounted on the base, a cartridge assembly having a plurality of trimming blades for trimming the material, a carriage slidably mounted on the rail, a selector comprising a plurality of engagement slots, and a set of pins for locking into the engagement slots of the selector knob in order to fix the positions of the selector knob and the plurality of trimming blades. The cartridge assembly plurality of trimming blades are rotatably connected to the selector, and the selector is capable of actuating the plurality of trimming blades by rotating on a plane perpendicular to the base.

### FIELD OF THE INVENTION

This invention relates generally to a cutting assembly for rotary trimmers, and is more particularly directed to a rotary multi-functional paper trimmer having such an assembly for applications within the office and similar use, wherein the cutter is mounted on a cutting board and slidably secured for cutting on a fixed rail, and which is characterized by selective vertical movement toward an underlying paper or other target to be cut, and by horizontal movement along the rail defining a plane upon which a cut is performed.

### BACKGROUND AND DESCRIPTION OF THE RELATED ART

Rotary cutters are well known in the art. Conventional cutters may be movably secured on and move in a horizontal plane along a rail, spring loaded or fixed. Examples of rotary cutters may be found in Patents issued to Johnson (U.S. Pat. No. 0,791,793), Mori (U.S. Pat. Nos. 5,069,097, 5,671,647), Boda (U.S. Pat. Nos. 5,322,001, 5,524,515), and Daley Jr. (U.S. Pat. No. 6,098,515), amongst others.

A common application of a rotary cutter is for trimming and efficiently cutting paper into small sheets. Please refer to FIG. 1, which illustrates an example of a conventional prior art paper cutter. The conventional paper cutter 10 includes a base 11, a guide rail 12, and a slidable carriage 13 with a trimming blade. The base 11 is for receiving the material to be trimmed, the rail 12 is fixed to the base 11, and the carriage 13 with a trimming blade is slidably mounted on the rail 12. The trimming blade that is mounted on the carriage 13 is a single specific trimming blade, such as a non rotating razor blade. When the paper is placed into the gap between the rail 12 and the base 11, the user may press down the carriage with the trimming blade 13 against the paper. If the user continues to apply downward pressure and to slide the carriage 13 with the trimming blade along the rail 12, the paper will be cut into two pieces by the blade mounted on the carriage 13.

The conventional paper cutter 10 described above is specifically used to divide paper completely with a straight edge finish. In the case that paper is to be intermittently cut (i.e. perforated) to be easily torn off by hand later, or scored with a folding line to be easily folded by hand, or provided any other type of edge finish (i.e. wavy, zig-zag, etc.), another kind of trimmer will be needed for the specific requirement. The use of multiple separate trimmers is cost ineffective and space inefficient. Accordingly, there are trimmers in the marketplace which require the user to interchange different blades for different trimmer effects. However, it is dangerous, time consuming and inconvenient for users to change these blades. In addition, the small loose blades tend to get lost when they are not in use.

Additionally, prior art conventional paper cutters 10, often cause the paper to become piled up or the blade to jam, when the blade slides on the paper due to the friction between the blade and the paper. To avoid this drawback, there are products in which a guiding slit is positioned on the base along the track upon which the blade slides. Though the design of the guiding slit may help to alleviate the piling up problem of the paper, it increases the complexity of the paper cutter.

### SUMMARY OF THE INVENTION

It is therefore a primary object of the claimed invention to provide a multi-functional trimming apparatus. The invention discloses a rotary trimming apparatus for cutting, perforating, or scoring a material. The rotary trimming apparatus includes a base for receiving the material, a rail mounted on the base, a plurality of trimming blades for cutting, perforating, or scoring the material, a carriage slidably mounted on the rail, a selector having a plurality of slots or holes, and a tongue or pins for engaging the slots or holes of the selector to fix a selected position of the selector and the plurality of trimming blades. The plurality of trimming blades are rotatably connected to the selector, and the selector is capable of actuating the plurality of trimming blades by rotating it in a plane perpendicular to the base. Additionally, the individual trimming blades may be free to rotate on their own axis, or they may be in a fixed state. The advantage of having the trimming blades free to rotate about their axis is that the blade exerts a downward perpendicular force in relation to the material to be processed, thereby minimizing the forces in the direction of travel exerted on the target material, which decreases the frictional force between the cutting element and the target material. By reducing the frictional force, the problem of the target material becoming piled up (i.e. jammed), when the blade slides on the paper due to the friction between the blade and the paper is greatly minimized.

An additional advantage of the present invention is that a plurality of different rotary trimming blades for rotating on the material and cutting, perforating, or scoring the material are utilized. Different trimming functions may be switched easily in the present device, and the trimming blade selected and being employed is clearly visible to the user by viewing graphic representation through a display window on the carriage. There is no assembly or disassembly required by the user to change the trimming blades. Thus there is no dangerous handling of sharp blades or inefficient lose of parts.

These and other objectives of the present invention will no doubt become apparent to those of ordinary skill in the art after reading the following detailed description of the preferred embodiments that are illustrated in the various figures and drawings.

### BRIEF DESCRIPTION OF THE DRAWINGS

FIG. 1 is a diagram of a prior art paper cutter.

FIG. 2 is a perspective illustration of a first embodiment of the present invention trimming apparatus.

FIGS. 3a and 3b is an exploded view of the multi-blade rotary cartridge assembly or magazine from its front and rear sides, respectively.

FIG. 4a is a front elevation view of a first trimming blade (straight cut) included in the present invention trimming apparatus.

FIG. 4b is a side elevation view of the first trimming blade shown in FIG. 4a.

FIG. 5a is a front elevation view of a second trimming blade (perforated cut) included in the present invention trimming apparatus.

FIG. 5b is a side elevation view of the second trimming blade shown in FIG. 5a.

FIG. 6a is a front elevation view of a third trimming blade (wavy cut) included in the present invention trimming apparatus.

FIG. 6b is a side elevation view of the third trimming blade shown in FIG. 6a.

FIG. 7a is a front elevation view of a fourth trimming blade (fold line) included in the present invention trimming apparatus.

FIG. 7b is a side elevation view of the fourth trimming blade shown in FIG. 7a.

FIG. 8 is an exploded view of the first embodiment of the cartridge for the trimming apparatus embodying the invention.

FIG. 9 is an exploded view of a second modified cartridge for the trimming apparatus embodying the invention.

FIG. 10 is a perspective view of the interior surface of the cover included in the second modified embodiment of the present invention.

### DETAILED DESCRIPTION OF THE PREFERRED EMBODIMENTS

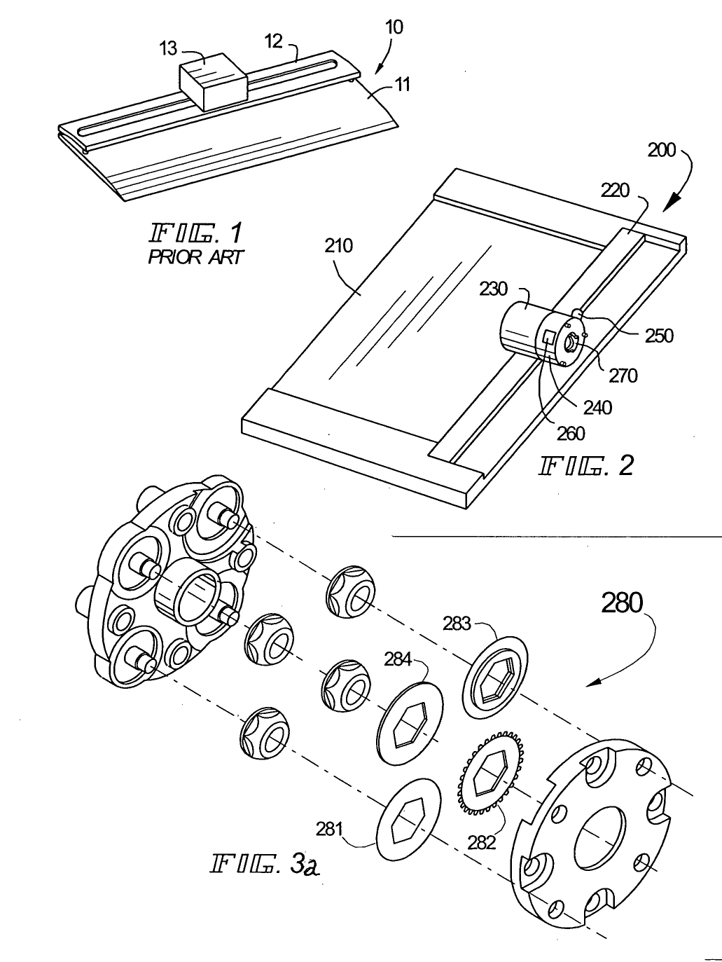

With reference to the accompanying drawings and particularly FIG. 2 a trimming apparatus 200 comprises a base 210, a rail 220, a carriage 230 slidably mounted on the rail, a selector 270, a cover 240, and a lever 250. The present invention is a multi-functional trimmer apparatus including a plurality of different trimming blades, wherein the trimming blades are rotatably connected to the selector 270. The selector 270 is ergonomically shaped to conform to the user's thumb and index fingers. The cover 240 includes an observation window 260 for viewing a graphic indication on the selector 270 of one of the several trimming blades being utilized by the trimming apparatus 200.

The rotary blade cartridge assembly 280 or magazine, shown in FIGS. 3a and 3b, 8, and 9, is fixed in relation to the selector 270. The rotary blade cartridge assembly 280 has a hole 289 that mounts and is free to rotate on a boss 232 that extends out from the body of the carriage 230. Circular protrusions or bosses 285, 286, 287, or 288, respectively, from the surface of the rotary blade cartridge 280 mate up with holes on the inner surface of the selector 270. The rotary blade cartridge assembly 280 rotates with the selector knob 270 as the user turns the selector knob to choose the required trimming blade. The rotary blade cartridge assembly 280 is made up of four trimming blades 281, 282, 283, and 284, respectively, which may be free to rotate on their own axes within the rotary blade cartridge assembly 280. The ability of the trimming blades 281, 282, 283, and 284, respectively, to freely rotate allows for a reduction in the friction generated between the selected trimming blade and the material to be cut, perforated, or scored. The resultant reduction in friction with the use of rotating trimming blades helps alleviate the problem of piling up (i.e. material jamming) in relation to a conventional paper cutter employing a fixed non-rotating blade.

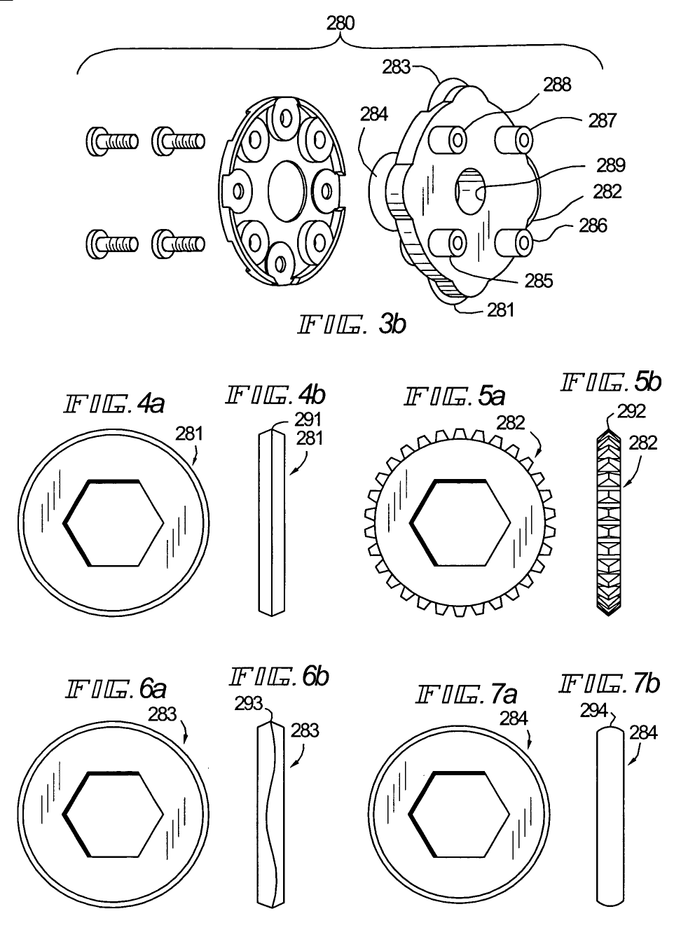

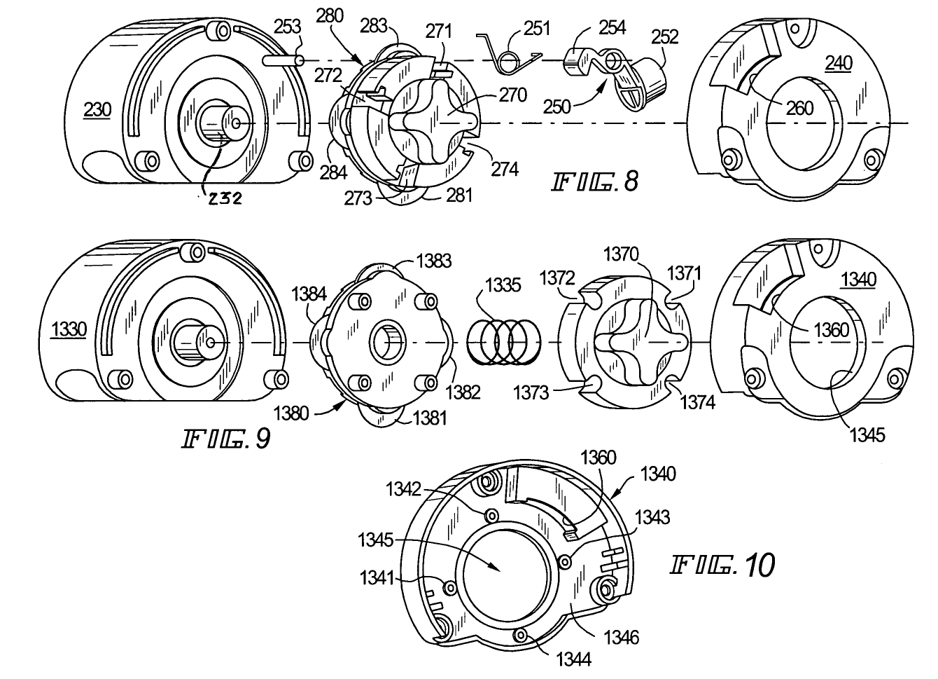

The first trimming blade 281 (FIG. 4a) is a rotary cutter, and has a sharp perimeter 291 (see FIG. 4b). When the present trimming apparatus 200 is switched to the trimming blade 281, the rotary cutter is capable of rotating on the material on the base 210, and cutting the material apart with a straight edge as the carriage is slide along the rail. The second trimming blade 282 (FIG. 5a) is a rotary gear-shaped blade, and has a sharp saw-tooth perimeter 292 (see FIG. 5b). When the trimming apparatus 200 is switched to this trimming blade 282, this gear shaped blade rotates on the material on the base 210, and makes a perforation cut on the material as the carriage is slid along the rail. The third trimming blade 283 (FIG. 6a) is a rotary wavy-line cutter, and its perimeter 293 (see FIG. 6b) is sharp and wavy. When this trimming apparatus 200 is switched to trimming blade 283, the sharp and wavy blade rotates on the material on the base 210, cutting the material apart in a wavy curve as the carriage slides along the rail. The fourth trimming blade 284 (FIG. 7a) is a rotary blunt blade 294 having an arcuate perimeter (see FIG. 7b) which forms a folding line on the material as the carriage slides along the rail.

The first embodiment of the cartridge embodying the present invention illustrated in FIG. 8 employs a lever mechanism 250 to lock the selector 270 and rotary blade assembly 280 in a user chosen position. The lever 250 is normally biased by a loading spring 251 in a down position, such that a tongue 254 inserts itself into one of the slots 271, 272, 273, or 274, respectively, located on the selector knob 270 assembly. However, the lever 250 is free to pivot about pin 253, and when the user requires the use of a different trimming blade than the one presently employed, the user applies downward pressure on the tab 252 to overcome the bias of the loading spring 251 thereby lifting the tongue 254 out of the present slot 271 that the tongue 254 had been resting in. With the lever mechanism 250 in the up position the selector 270 and the rotary blade cartridge assembly 280 is free to rotate. Therefore, the user is able to turn the selector 270 and the rotary blade cartridge assembly 280 until the desired blade is in position. When the required trimming blade is in position, the user releases the downward pressure applied to the knob 252, of the lever mechanism 250, and the selector 270 and the rotary blade cartridge assembly 280 will be re-locked with the tongue 254 reinserted into one of the slots 271, 272, 273, or 274 located on the selector 270 assembly.

The second embodiment of the present invention illustrated in FIGS. 9 and 10 employs a series of engagement pins 1341, 1342, 1343, and 1344, respectively, slots 1371, 1372, 1373, and 1374, respectively, and a spring loaded selector 1370 to lock the rotary blade cartridge assembly 1380 in a user selectable position. The selector 1370 is normally biased to press outwardly through the hole 1345 on the cover 1340 by a compression spring 1335, such that all four slots 1371, 1372, 1373, 1374 are engage with all four of the engagement pins 1341, 1342, 1343, 1344, located on the inner surface 1346 of the cover assembly 1340. When a different trimming blade 1381, 1382, 1383, or 1384 is required the user pushes the selector knob 1370 inward toward the carriage 1330 to overcome the outward bias of the spring 1335, and disengage all four pins 1341, 1342, 1343, and 1344 from the four slots 1371, 1372, 1373, and 1374. With inward pressure applied to the selector 1370, the user is free to rotate the selector 1370 until the desired trimmer blade 1381, 1382, 1383, or 1384 is in position. When one of the required trimmer blades 1381, 1382, 1383, or 1384 is in position, the user removes the applied inward pressure to the selector knob 1370, and the four engagement pins 1341, 1342, 1343, and 1344, located on the inner surface 1346 of the cover assembly 1340 engage in an indexable manner corresponding to the blade selection, with the four slots 1371, 1372, 1373, 1374 of the selector knob 1370, thereby re-locking both the selector knob 1340 and the rotary blade cartridge assembly 1380. An observation window 1360 located on the cover 1340 provides the user with a graphic indication of which one of the trimmer blades 1381, 1382, 1383, or 1384 is exposed and available to cut, perforate, or score the target material. When the blades in the magazine 280 become worn or if a blade is broken, the entire magazine, with its blades in place, may be easily removed and replaced, without danger to the user of unintended cuts.

Those skilled in the art will readily observe that numerous modifications and alterations of the device may be made without departing from the spirit or scope of the invention. Accordingly, the above disclosure should be construed as limited only by the appended claims.

I claim:

1. A rotary trimming apparatus for trimming a material comprising:
a base for receiving the material;
a rail mounted on the base; and
a carriage slidably mounted on the rail, said carriage comprising;
a cover;
a rotary blade assembly, said assembly having:
a plurality of trimming blades for trimming the material, rotatably connected to the rotary blade assembly;
a selector connected to said rotary blade assembly capable of actuating the plurality of trimming blades by rotating the selector, said selector further comprising a plurality of engagement means; and
a locking device for engaging said engagement means to fix the positions of the selector and the rotary blade assembly.

2. The apparatus of claim 1 wherein the locking device comprises:
a lever pivotably connected to the carriage;
a biasing spring; and
a tab for the user to apply pressure;
said lever further having a tongue adapted to engage said engagement means to fix the positions of the selector and the rotary blade assembly.

3. The apparatus of claim 2 wherein said tongue is engaged with said engagement means when the tab is at a first position, and the tongue is disengaged from said engagement means when the tab is at a second position when pressure is applied to the tab.

4. The apparatus of claim 1 wherein said cover has a plurality of engagement pins on its inner surface.

5. The apparatus of claim 4 wherein said locking device is integral to said cover, and has:
a spring;
and said plurality of engagement pins are adapted for engaging said plurality of engagement means to fix the position of said selector and said rotary blade assembly when said plurality of engagement pins are engaged with said plurality of engagement means.

6. The apparatus of claim 5 wherein said selector is free to rotate when said plurality of engagement pins are disengaged from said plurality of engagement means when pressure is applied to said selector toward said carriage in opposition to said spring.

7. The apparatus of claim 5 wherein said spring is a compression spring.

8. The apparatus of claim 1 wherein said plurality of trimming blades has a first trimming blade, and the perimeter of said trimming blade is sharp and is adapted to cut in a straight line.

9. The apparatus of claim 1 wherein the plurality of trimming blades has a second trimming blade, and the perimeter of said second trimming blade comprises sharp saw-teeth and is adapted to cut a perforated line.

10. The apparatus of claim 1 wherein said plurality of trimming blades has a third trimming blade, and the perimeter of the third trimming blade is wavy and is adapted to cut a wavy line.

11. The apparatus of claim 1 wherein said plurality of trimming blades has a fourth trimming blade, and the perimeter of said fourth trimming blade is blunt and is adapted to form a foldable line.

12. The apparatus of claim 1 wherein said selector has a plurality of graphic indicators corresponding to the plurality of trimming blades.

13. The apparatus of claim 12 wherein said cover has an observation window for observing an indication on the selector of which trimming blade is being utilized.

14. The apparatus of claim 1 wherein the selector is ergonomically shaped to conform to the users thumb and index fingers.

15. The apparatus of claim 1 wherein selectively removable fasteners secure said cover to said carriage for ease of removal of the cover.

16. The apparatus of claim 15 wherein said fasteners comprise thumb screws manipulatable to expose said rotary blade assembly

17. The apparatus of claim 1, wherein said rotary blade assembly comprises a magazine enclosing each of said blades except a blade arranged in trimming position.

18. The apparatus of claim 1, wherein a blade is arranged in trimming position without a user touching the cutting edge of said blade.

19. The apparatus recited in claim 1, wherein said rotary blade assembly comprises a magazine selectively removable from said carriage for change-out of worn or broken blades.

20. A rotary trimming apparatus for trimming a material comprising:
a base for receiving the material;
a rail mounted on the base; and
a carriage slidably mounted on the rail, said carriage comprising;
a cover;
a rotary blade assembly having
a plurality of trimming blades for trimming the material rotatably connected to the rotary blade assembly;
a selector connected to said rotary blade assembly capable of actuating the plurality of trimming blades by rotating said assembly on a plane perpendicular to the base,
said selector further having a plurality of engagement slots; and
a locking device for engaging with said engagement slots to fix the positions of the selector and the rotary blade assembly.

21. In the rotary trimming apparatus recited in claim 20, wherein said locking device consists of tab means selectively adapted for engagement in said engagement slots.

22. A cartridge for removable seating in a carriage slideably mounted on a rail of a rotary trimmer apparatus and containing trimming blades adapted for cutting, scoring or perforating a material, said cartridge comprising:
an outer shell,
an inner shell,
said trimming blades mounted between said outer and inner shells,
at least one of said trimming blades having a cutting edge extending from said carriage when mounted therein,
said blades except for said cutting edge being protected and covered by said carriage.

23. In the cartridge recited in claim 22, wherein said cartridge is adapted for indexable mounting in said carriage.

24. In the cartridge recited in claim 22, wherein said blades are spaced around the periphery of said cartridge.

25. In the cartridge recited in claim 22, wherein some of said blades are rotatable in said cartridge.

26. In the cartridge recited in claim 25, wherein said blades are removably secured in said cartridge.
